(19) United States
(12) Patent Application Publication
(10) Pub. No.: US 2012/0308852 A1
(43) Pub. Date: Dec. 6, 2012

(54) TREATMENT APPARATUS AND TREATMENT METHOD

(76) Inventor: Takashi KONO, Okazaki-shi (JP)

(21) Appl. No.: 13/483,224

(22) Filed: May 30, 2012

(30) Foreign Application Priority Data
Jun. 3, 2011 (JP) 2011-125289

(51) Int. Cl. H01M 10/42

(52) U.S. Cl. 429/49

(57) ABSTRACT

A disperser regenerates an adsorbed water layer on a surface layer of a DLC-Si film by replenishing water to the DLC-Si film, for example, during treatment or following the completion of treatment.

### INCORPORATION BY REFERENCE

The disclosure of Japanese Patent Application No. 2011-125289 filed on Jun. 3, 2011 including the specification, drawings and abstract is incorporated herein by reference in its entirety.

### BACKGROUND OF THE INVENTION

1. Field of the Invention

The invention relates to a treatment apparatus and a treatment method for charging a material into a vessel having a blade coated on the surface with a silicon-containing diamond-like carbon (DLC-Si) film and carrying out treatment.

2. Description of Related Art

The use of electrically powered vehicles such as hybrid vehicles and electric cars equipped with a motor as the source of driving power has been widely spread. Such electrically powered vehicles are equipped with rechargeable batteries for carrying out charging and discharging. The electrodes used in the rechargeable batteries have thereon a coat which has been formed by applying a liquid coating containing an active material, a conductive additive, a binder and a solvent to the surface of a strip of metal foil (substrate), and drying the applied liquid. In this rechargeable battery, when charging and discharging are carried out, ion insertion and extraction occur between the positive electrode active material contained in the applied film on the positive electrode and the negative electrode active material contained in the applied film on the negative electrode. In order to suitably carry out ion insertion and extraction, the active materials, conductive additives and binders must be uniformly dispersed within the applied films. It is thus necessary, while in the state of a liquid coating, for the active material, conductive additive, binder and the like to be uniformly dispersed within the solvent. For this reason, the liquid coating is subjected to mixing and dispersion.

Examples of conventional dispersers include apparatuses which have a dispersing vessel wherein a stator is fixed and a rotor is rotatably held, and which use stator blades formed on the stator and rotor blades formed on the rotor to disperse a liquid coating that has been placed within the dispersing vessel. The rotor blades, which are disposed opposite the fixed stator blades, rotate at a high speed, applying a high shear speed to the liquid coating, and can thereby uniformly disperse the active material, conductive additive, binder and the like within the solvent. However, the lithium active material of the positive electrode is very hard, having a Vickers hardness Hv of about 1,000. As a result, the lithium active material, upon colliding with the rotor blades and stator blades of the disperser at intense speeds, wears these blades down in a short time. Japanese Patent Application Publication No. 2011-001598 (JP-2011-001598 A) teaches how, by forming a DLC film on the surface of a sliding member (a clutch plate) and providing a silicon (Si)-containing layer on the surface of the DLC film, the wear resistance is increased, preventing the DLC film from peeling.

The formation of a DLC-Si film on the surface of disperser stator blades and rotor blades increases the wear resistance of the DLC film and can indeed have the effect of preventing the DLC film from peeling. However, even in cases where a DLC-Si film has been formed, when the rotational speed of the rotor is raised to 3,000 rpm or more, imparting high shear speeds of γ=5,000/s to 50,000/s, the DLC-Si film wears away in a short time, making durability a problem. In areas where the DLC-Si film has been worn away and disappeared, the blade metal becomes exposed. The metal is eroded by the lithium active material, and the eroded metal (e.g., stainless steel (SUS)) then enters to the liquid coating and may ultimately have a detrimental effect on battery performance. According to experiments conducted by the inventors, DLC-Si films have a durability of about 3,000 hours. During long-term use of the disperser, the frequency of blade replacement is high, which has been a major factor in increasing production costs.

### SUMMARY OF THE INVENTION

Accordingly, the invention provides a treatment apparatus (such as a disperser) and a treatment method in which the service life of metal members (such as blades) having a DLC-Si film formed thereon can be made longer than in conventional treatment apparatus.

According to a pump aspect, the invention relates to a treatment apparatus including a vessel, a metal member that is disposed inside the vessel and is coated on a surface thereof with a DLC-Si film, and a water replenishing unit that replenishes the DLC-Si film with water so as to regenerate an adsorbed water layer on a surface layer of the DLC-Si film.

The metal member may be a blade.

The material to be treated may include as battery materials an active material, a conductive additive and a binder, and also a solvent, and the treatment apparatus may be adapted to mix the material to be treated.

In this case, even when an active material having a high hardness is mixed, the service life of the blades in a disperser, for example, can be increased, enabling production costs to be reduced.

The active material may be a metal oxide.

Even when a metal oxide having a high hardness is mixed, the service life of the blades in a disperser, for example, can be increased, enabling production costs to be reduced.

The treatment apparatus may, after the water replenishment has been carried out, displace with the solvent any water other than the water which has formed the adsorbed water layer.

After an adsorbed water layer has formed over the entire surface of the DLC-Si film, by displacing all of the remaining water with solvent, the undesirable admixture of water in the battery materials can be prevented.

The DLC-Si film may have a thickness of 5 μm or less and the treatment apparatus may include a disperser having a fixed stator and a rotating rotor, which rotor may have a rotational speed of at least 3,000 rpm but not more than 10,000 rpm.

In the disperser for dispersing a lithium active material-containing battery material, to avoid peeling of the DLC-Si film, the DLC-Si film thickness is set to 0.5 μm to 5.0 μm. Also, to achieve a high shear rate of γ=5,000 to 50,000, the rotational velocity of the rotor is set to 3,000 rpm to 5,000 rpm. Even a disperser used under such severe conditions will, owing to the effects of the invention, have a useful service life of 6,500 hours compared with a useful service life of 3,000 hours for a conventional disperser used under the same conditions. This represents a more than doubling of the useful service life, enabling the useful service life (the period until replacement is needed) of the blades in the disperser to be extended more than two-fold, and thus making it possible to reduce production costs.

According to a second aspect, the invention relates to a treatment method which includes: charging a material to be treated into a vessel having a metal member coated on a surface thereof with a DLC-Si film; treating the charged material; and replenishing, after the treatment of the material, water on the DLC-Si film so as to regenerate an adsorbed water layer on a surface layer of the DLC-Si film.

According to a third aspect, the invention relates to a treatment apparatus including a disperser having a vessel and a metal member that is disposed inside the vessel and is coated on a surface thereof with a DLC-Si film, a charging unit that charges a plurality of materials into the vessel, a rotating unit that rotates the metal member so as to mix the plurality of materials, and a water replenishing unit that replenishes the DLC-Si film with water so as to regenerate an adsorbed water layer on a surface layer of the DLC-Si film after mixing the plurality of materials.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a disperser 10;

FIG. 2 is a perspective view of a stator 12;

FIG. 3 is a perspective view of a rotor 13;

FIG. 4 is a view showing a system configuration for the mixing and dispersing steps according to the invention;

FIG. 5 shows diagrams illustrating the technical significance of the water replenishing step;

FIG. 6 is a diagram showing repetitive test data;

FIG. 7 is a data chart showing the battery materials used in an embodiment; and

FIG. 8 is a data chart showing the typical properties of a DLC-Si film and a lithium active material.

### DETAILED DESCRIPTION OF EMBODIMENTS

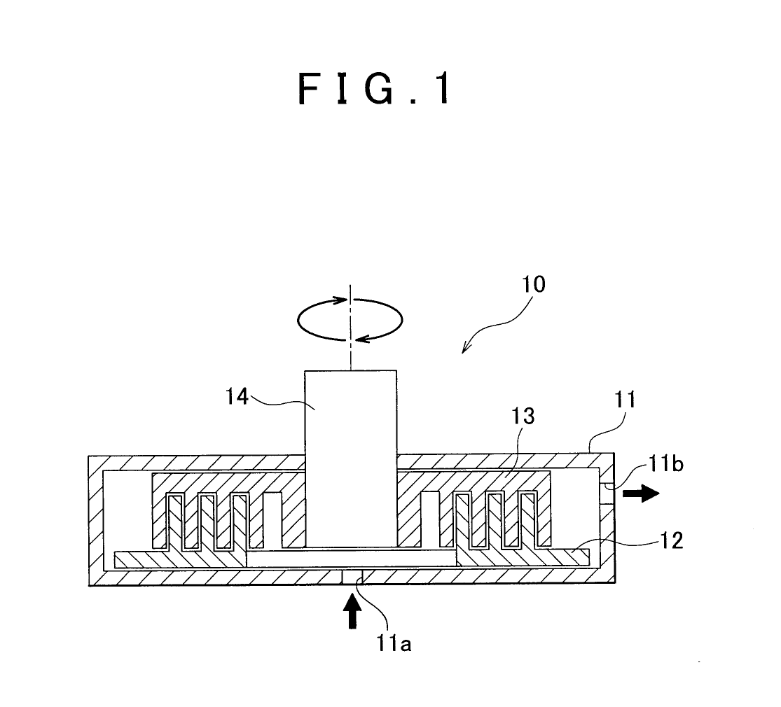

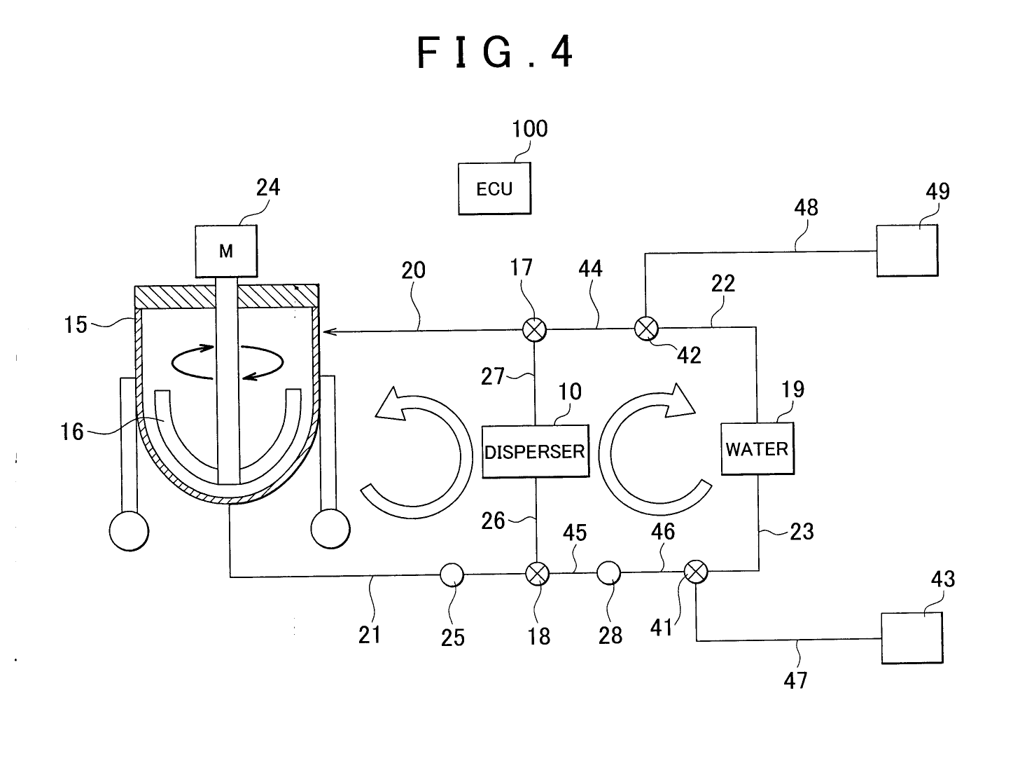

A disperser is described in detail below, in conjunction with the accompanying diagrams, as an example of a batch treatment apparatus according to the invention. FIGS. 1 and 4 show mixing and dispersing steps (mixing unit, disperser) according to embodiments of the invention. A line 21 which connects to the bottom end of a mixing tank 15 is connected to a pump port on a three-way valve 18. A pump 25 is provided on the line 21. A common port on the three-way valve 18 is connected through a line 26 to an inlet port 11a on a disperser 10. A second port on the three-way valve 18 is connected through a line 45 to an outlet port on a pump 28. An inlet port on the pump 28 is connected through a line 46 to a common port on a three-way valve 41. A pump port on the three-way valve 41 is connected through a line 23 to a water tank 19. A second port on the three-way valve 41 is connected through a line 47 to a solvent tank 43. An outlet port lib on the disperser 10 is connected through a line 27 to a three-way valve 17. A pump port on the three-way valve 17 is connected through a line 20 to the top of the mixing tank 15. A second port on the three-way valve 17 is connected through a line 44 to a common port on a three-way valve 42. A pump port of the three-way valve 42 is connected through a line 22 to the water tank 19. A second port on the three-way valve 42 is connected through a line 48 to a wastewater tank 49. The mixing tank 15 has a capacity of about 20 liters. A mixing blade 16 for mixing is rotatably held on a rotary shaft 14 in the mixing tank 15. The mixing blade 16 is rotated by a motor 24. An engine control unit (ECU) 100 controls the motor 24, the three-way valve 17, the three-way valve 18, the three-way valve 41, the three-way valve 42, the pump 25, the pump 28, and the rotary shaft 14.

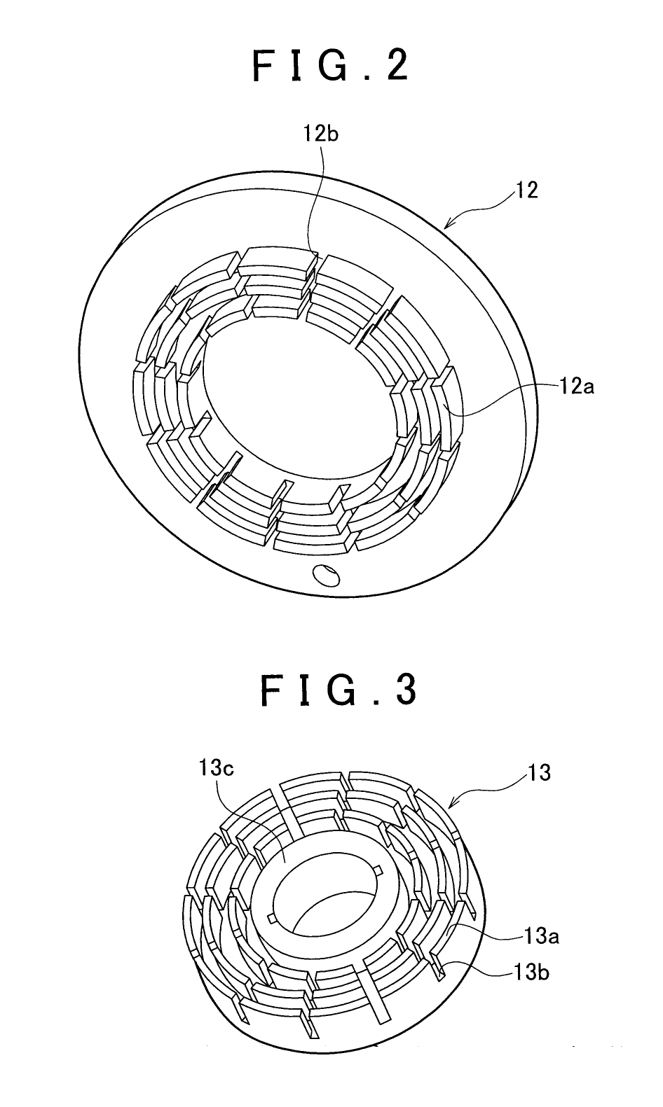

FIG. 1 shows a sectional view of the disperser 10. An inlet port 11a is formed on a bottom face of a closed dispersing vessel 11, and an outlet port 11b is formed on a peripheral top portion. A stator 12 is fixed within the dispersing vessel 11. In addition, a rotor 13 is rotatably held within the dispersing vessel 11. FIG. 2 shows a perspective view of the stator 12. The stator 12 has three rows of stator blades 12a standing upright on one side of a disk. The three rows of stator blades 12a are each divided by stator gaps 12b into twelve individual pieces. The rotor 13 is cylindrically shaped and has three rows of rotor blades 13a arranged thereon. The three rows of rotor blades 13a are each divided by rotor gaps 13b into twelve individual pieces. A rotor boss 13c is formed at the center of the rotor 13. The rotary shaft 14 is connected to the rotor boss 13c. The rotary shaft 14 is rotated by a motor (not shown). As shown in FIG. 1, the three rows of rotor blades 13a are arranged so as to alternately interpenetrate the three rows of stator blades 12a. The volume of liquid coating that enters the disperser 10 is about 500 cc. The pump 25 has a capacity of 20 L/min to 60 L/min.

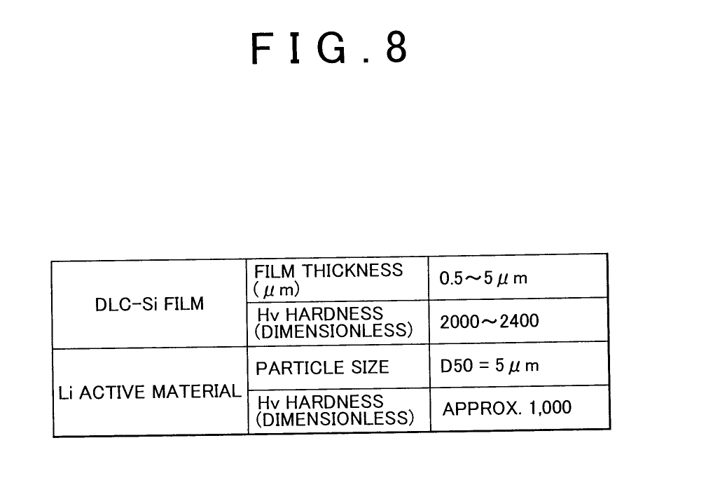

The rotor blades 13a and the stator blades 12a are made of SUS, and have a 5 μm thick DLC-Si film formed on the surface thereof. As shown in FIG. 8, the DLC-Si film has a Vickers hardness HV of 2,000 to 2,400. The battery material used in this embodiment is shown is FIG. 7. The active material is a metal oxide. The lithium active material LiNi_{0.33}Co_{0.33}Mn_{0.33}O₂ is used as the metal oxide in this embodiment, and typically has a particle size (D₅₀) of 5 μm. Acetylene black is used as the conductive additive, and typically has a primary particle size of 50 nm. Polyvinylidene fluoride (PVDF) is used as the binder, and typically has a molecular weight of 300,000. N-methyl-2-pyrrolidone (NMP) is used as the solvent. Here, the weight ratio between the LiNi_{0.33}Co_{0.33}Mn_{0.33}O₂, acetylene black, PVDF and NMP is 90:2:8:100. FIG. 8 shows the properties of the DLC-Si film and the lithium active material. As shown in FIG. 8, the lithium active material has a Vickers hardness Hv of about 1,000 and the conductive additive has a hardness Hv of about 100.

In this embodiment, the rotor blades 13a have a rotational velocity of at least 3,000 rpm but not more than 10,000 rpm. Because the outer peripheral surfaces of the rotor blades 13a are arranged in close proximity with the inner peripheral surfaces of the stator blades 12a, the inner peripheral surfaces of the rotor blades 13a are arranged in close proximity with the outer peripheral surfaces of the stator blades 12a, and the rotor blades 13a rotate at a rotational velocity of 3,000 rpm to 10,000 rpm, the shear velocity of the liquid coating in the gaps where the rotor blades 13a and the stator blades 12a are in close proximity is from 3,000/s to 6,000/s. At such a high shear velocity, in the liquid coating, the active material, conductive additive and binder are uniformly dispersed within the solvent. Here, the shear velocity refers to the numerical value obtained by dividing the relative velocity (units, m/s) of the rotor blades 13a with respect to the stator blades 12a by the length (units, m) of the gaps between the rotor blades 13a and the stator blades 12a.

Next, a method of operating a system configured as shown in FIG. 4 is described. In a dispersion step, by having the common port (line 26) and the pump port (line 21) of the three-way valve 18 communicate, and having the common port (line 27) and the pump port (line 20) of the three-way valve 17 communicate, there is formed a liquid flow circuit which passes from the mixing tank 15 through line 21, the pump 25, the three-way valve 18, line 26, the disperser 10, line 27, the three-way valve 17 and the line 20, returning to the mixing tank 15. By then driving the pump 25, the liquid coating within the mixing tank 15 is fed to the disperser 10 at a flow rate of 20 L/min. Here, the three-way valve 18 cuts off flow between lines 26 and 45, and the three-way valve 17 blocks cuts off between lines 27 and 44. The liquid coating supplied from the inlet port 11a passes through the rotor gaps 13b and the stator gaps 12b, and is discharged from the outlet port 11b. Inside the disperser 10, a higher shear velocity of 5,000/s to 50,000/s is applied by the stator blades 12a and the rotor blades 13a. Because a high shear velocity is applied to the liquid coating, the lithium active material, conductive additive and binder are uniformly dispersed within the solvent. In this embodiment, such a dispersing step is carried out continuously for 10 hours.

After the dispersing step has been carried out continuously for 10 hours, the process moves on to a water feeding step. That is, the three-way valve 18 is switched so as to place the common port (line 26) and the second port (line 45) in a communicating state, and the three-way valve 17 is switched so as to place the common port (line 27) and the second port (line 44) in a communicating state. At the same time, the three-way valve 41 is switched so as to place the common port (line 46) and the first port (line 23) in a communicating state, and the three-way valve 42 is switched so as to place the common port (line 44) and the first port (line 22) in a communicating state.

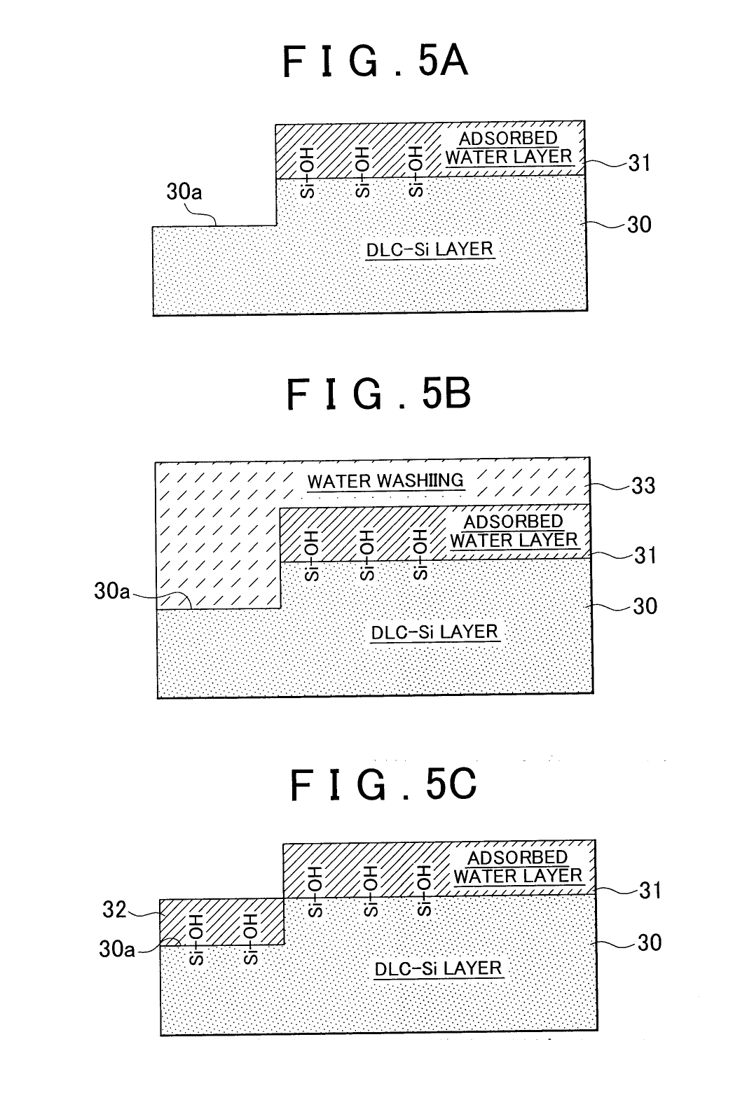

As a result, there is formed a liquid flow circuit which passes from the water tank 19 through the line 23, the three-way valve 41, the line 46, the pump 28, the line 45, the three-way valve 18, line 26, the disperser 10, the line 27, the three-way valve 17, the line 44, the three-way valve 42 and the line 22, returning to the mixing tank 19. By then driving the pump 28, water is fed to the disperser 10. The DLC-Si film is replenished with water in this way. Here, the three-way valve 41 cuts off flow between the line 47 and both lines 23 and 46, the three-way valve 42 cuts off flow between the line 48 and both lines 22 and 44, the three-way valve 18 cuts off flow between the line 21 and both lines 26 and 45, the three-way valve 17 cuts off flow between the line 20 and both lines 27 and 44, and the three-way valve 42 cuts off flow between the line 48 and both lines 22 and 44. The technical significance of this is explained while referring to FIG. 5. FIG. 5A shows the state of the DLC-Si film immediately after the dispersing step has been completed. Silica (SiO₂) has formed on the surface of the DLC-Si film 30 and is thought to adsorb water. Due to OH groups (the OH groups in water) which have bonded with silicon in the DLC-Si film, an adsorbed water layer 31 has formed on part of the surface of the DLC-Si film 30. However, on a surface 30a where part of the DLC-Si film has fallen off, because of a dearth of silica, not much of an adsorbed water layer 31 appears to be present.

When the lithium active material strikes a surface on which an adsorbed water layer 31 is present at a high velocity, the adsorbed water layer 31 plays the role of a lubricant, lowering the frictional resistance, as a result of which the wear resistance is high and little surface damage occurs. By contrast, when the lithium active material strikes a surface having little adsorbed water layer 31 thereon at a high velocity, there is no reduction in frictional resistance by the adsorbed water layer 31, as a result of which the DLC-Si film is directly damaged. In this embodiment, water replenishment is carried out before such a state arises. FIG. 5B shows a state in which water has been fed to the disperser 10 and the water 33 has adhered to the surface of the DLC-Si film 30. By supplying water 33 to the surface of the DLC-Si film, as shown in FIG. 5C, owing to OH groups (OH groups in water) which have bonded with silicon in the DLC-Si film, an adsorbed water layer 32 forms even on the surface 30a where part of the DLC-Si film has fallen off. This constitutes the water replenishing step.

Next, the pump 28 is stopped, the three-way valve 41 is switched so as to have the common port (line 46) and the second port (line 47) communicate, and the three-way valve 42 is switched so as to have the common port (line 44) and the second port (line 48) communicate. As a result, there is formed a liquid flow circuit from the solvent tank 43 to the line 47, the three-way valve 41, the pump 28, the line 45, the three-way valve 18, the line 26, the disperser 10, the line 27, the three-way valve 17, the line 44, the three-way valve 42, the line 48 and the wastewater tank 49. By then driving the pump 28, solvent is fed into the disperser 10, thereby displacing water that was inside the disperser 10, the line 26, line 27, the three-way valve 18 and the three-way valve 17 with solvent. This constitutes the displacing step. Here, the three-way valve 41 cuts off lines 47 and 23, the three-way valve 42 cuts off lines 22 and 48, the three-way valve 18 cuts off lines 45 and 21, and the three-way valve 17 cuts off lines 27 and 20.

Next, the pump 28 is stopped, the three-way valve 17 is switched, bringing the common port (line 27) and first port (line 20) into communication, and the three-way valve 18 is switched, bringing the common port (line 26) and the first port (line 21) into communication. Then, by driving the pump 25, the dispersing step is again carried out. The dispersing step is carried out continuously for about 10 hours. Here, in the course of the dispersing step, even when the lithium active material collides at a high velocity with the DLC-Si film that has been formed on the surfaces of the stator blades 12a and the rotor blades 13a of the disperser 10, because, as shown in FIG. 5C, an adsorbed water layer 32 has formed even on surfaces where part of the DLC-Si film has fallen off, the adsorbed water layers 32, 31 play the role of a lubricant, reducing the frictional resistance and thus making it possible to increase the wear resistance and durability of the DLC-Si film.

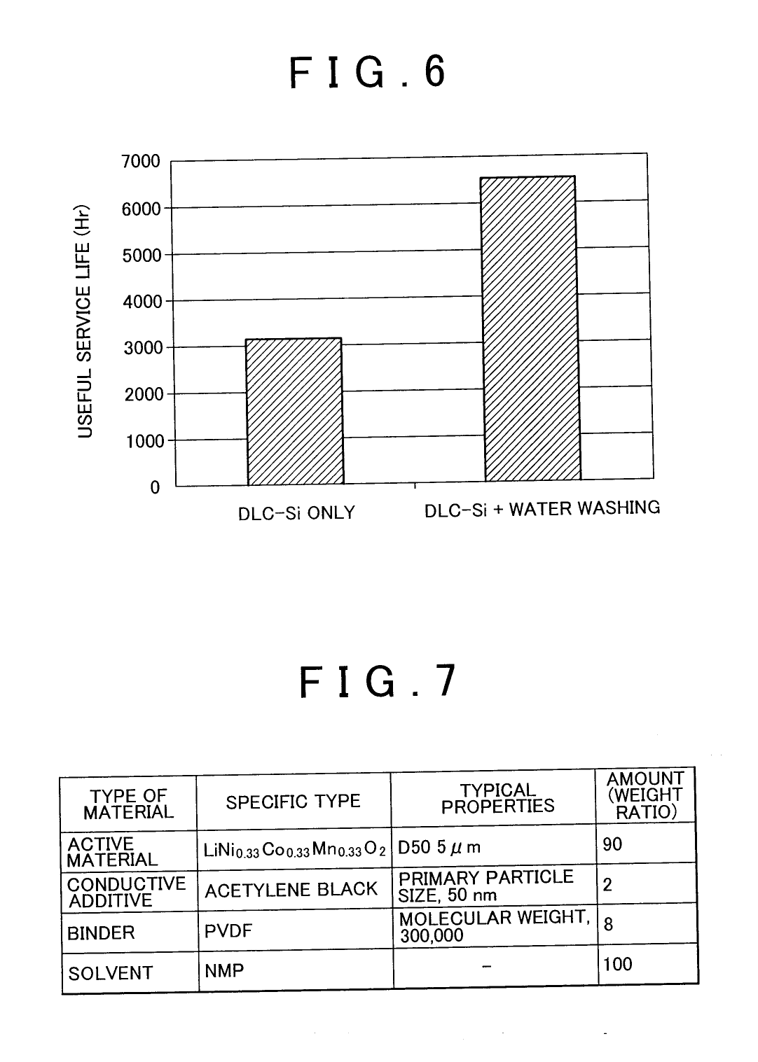

Next, the effects of this embodiment are described. FIG. 6 shows the effects of the embodiment as repetitive test data. “DLC-Si only” represents the data for a conventional system, and “DLC-Si+water washing” represents the data for a system according to this embodiment. In the tests, the DLC-Si film, materials, apparatus and the like used were identical for both systems, the only difference being the presence or absence of water replenishment (water washing). Each time the dispersing step was carried out for 100 hours, the stator plate 12a and the rotor plate 13a were broken and the cross-section was examined, the amount of wear was measured, and the useful service life was estimated. In the conventional system, repetitive testing was performed in which the dispersing step alone is carried out continuously for 100 hours. As a result, when 3,000 hours had elapsed, peeling of the DLC-Si film was observed, from which it was apparent that the limits of the useful life had been reached. By contrast, the system according to the embodiment was one in which, after the dispersing step had been carried out for 10 hours, a water replenishing step and a displacing step were carried out, following which a dispersing step was again carried out, this cycle being repeated ten times. With the system according to this embodiment, peeling of the DLC-Si film was observed when 6,500 hours had elapsed. It was thus apparent that the DLC-Si film could be used in this embodiment for a period of time at least twice as long as in the conventional system.

In cases where an active material, conductive additive, binder and solvent are subjected to treatment by being dispersed using the disperser 10 of this embodiment, by replenishing water 33 to the DLC-Si film 30, either between each treatment cycle or following the completion of treatment, an adsorbed water layer 32 is regenerated on the surface layer of the DLC-Si film 30. Hence, because the surface of the DLC-Si film 30 is always in a state in which adsorbed water layers 31, 32 have been formed, frictional resistance with the lithium active material can be reduced, enabling the wear resistance of the DLC-Si film 30 to be increased.

In conventional dispersers, moisture in the air is generally taken up onto the surface of the DLC-Si film, resulting in the formation of an adsorbed water layer. In cases where a sliding member or the like having a DLC-Si film formed on the surface is used in air, an adsorbed water layer forms on the surface of the DLC-Si film as a result of moisture in the air.

However, in a disperser for a battery material, because the battery material reacts with moisture, the disperser is always filled with solvent. For this reason, once the adsorbed water layer on the surface of the DLC-Si film has been removed by the lithium active material, the adsorbed water layer cannot be regenerated, lowering the wear resistance. This was first discovered by the inventor. One way to address this problem is to expose the blade surfaces to air once the solvent has been completely removed. However, such an approach takes time. It is possible instead, following dispersion treatment of the electrode material, to regenerate adsorbed water layers 31, 32 in a short time on all the surfaces of the DLC-Si film 30 by bringing the blade surfaces into contact with liquid water. In experiments by the inventor, compared with a useful service life of 3,000 hours in a conventional system when treatment was carried out under the same conditions, the useful service life of the system according to the embodiment was 6,500 hours, representing at least a two-fold increase. This means that the replacement period for the blades used in the disperser can be at least doubled, enabling production costs to be reduced.

In the above-described treatment apparatus, following water replenishment, water other than that which has formed the adsorbed water layers 31, 32 is displaced with solvent. Hence, after the adsorbed water layers 31, 32 have been formed over the entire surface of the DLC-Si film 30, all the water can be displaced with solvent, making it possible to prevent the undesirable admixture of water in the battery material.

In the disperser 10 which disperses a lithium active material-containing battery material, to avoid peeling of the DLC-Si layer 30, the thickness of the DLC-Si layer 30 is set to 0.5 μm to 5.0 μm. Moreover, to obtain a high shear velocity of γ=5,000 to 50,000, the rotational velocity of the rotor 13 is set to 3,000 rpm to 5,000 rpm.

Even when the disperser has been used under such harsh conditions, compared with the useful service life of 3,000 hours in a conventional system where treatment has been carried out under the same conditions, the useful service life in the system according to this embodiment is 6,500 hours, representing at least a two-fold increase. This means that the replacement period for the blades used in the disperser can be at least doubled, enabling production costs to be reduced.

The abovementioned embodiment and modifications thereto are exemplary and are not limited to this invention, and various improvements and variations may be made without departing from the spirit and scope of the invention. For example, although the disperser 10 for a battery material has been described in the foregoing embodiment, the invention may be applied in any situation where the DLC-Si film is used within a closed vessel which presents no opportunities for contact with air or water. Also, in the above embodiment, the water replenishing step is inserted between treatments at 10 hour intervals, but in the case of treatment operations lasting about 20 hours, water replenishment may be carried out following completion of the treatment operation. Moreover, the thickness of the DLC-Si film 30 was set to 5 μm in the above embodiment, but use in a disperser 10 is possible at a film thickness within a range of from 0.5 μm to 5.0 μm.

What is claimed is:

1. A treatment apparatus, comprising:
a vessel;
a metal member that is disposed inside the vessel and is coated on a surface thereof with a silicon-containing diamond-like carbon (DLC-Si) film; and
a water replenishing unit that replenishes the DLC-Si film with water so as to regenerate an adsorbed water layer on a surface layer of the DLC-Si film.

2. The treatment apparatus according to claim 1, wherein the metal member is a blade.

3. The treatment apparatus according to claim 1, wherein
a material to be treated includes as battery materials an active material, a conductive additive, and a binder, and also a solvent, and
the treatment apparatus mixes the material to be treated.

4. The treatment apparatus according to claim 3, wherein the active material is a metal oxide.

5. The treatment apparatus according to claim 3, further comprising:
a displacement unit that, after the water replenishment has been carried out, displaces with the solvent any water other than the water that has formed the adsorbed water layer.

6. The treatment apparatus according to claim 3, wherein
the DLC-Si film has a thickness of 5 μm or less,
the metal member includes a stator and a rotor, and
the rotor has a rotational speed of at least 3,000 rpm but not more than 10,000 rpm.

7. A treatment method comprising:
charging a material to be treated into a vessel having a metal member coated on a surface thereof with a silicon-containing diamond-like carbon (DLC-Si) film;
treating the charged material; and
replenishing, after the treatment of the material, water on the DLC-Si film so as to regenerate an adsorbed water layer on a surface layer of the DLC-Si film.

8. The treatment method according to claim 7, wherein
the material includes as battery materials an active material, a conductive additive and a binder, and also a solvent, and
the treatment of the material includes mixing the material.

9. The treatment method according to claim 8, wherein the active material is a metal oxide.

10. The treatment method according to claim 8, further comprising,
after the water replenishment, displacing with the solvent any water other than the water which has formed the adsorbed water layer.

11. The treatment method according to claim 8, wherein
the DLC-Si film has a thickness of 5 μm or less,
the metal member includes a stator and a rotor, and
the rotor has a rotational speed of at least 3,000 rpm but not more than 10,000 rpm.

12. A treatment apparatus comprising:
a disperser having a vessel and a metal member that is disposed inside the vessel and is coated on a surface thereof with a silicon-containing diamond-like carbon (DLC-Si) film,
a charging unit that charges a plurality of materials into the vessel,
a rotating unit that rotates the metal member so as to mix the plurality of materials, and
a water replenishing unit that replenishes the DLC-Si film with water so as to regenerate an adsorbed water layer on a surface layer of the DLC-Si film after mixing the plurality of materials.

13. The treatment apparatus according to claim 12, wherein the vessel is closed while the plurality of materials are being mixed so that water is not supplied to the vessel.

14. The treatment apparatus according to claim 12, further comprising:
a mixer that additionally mixes the plurality of materials that have been mixed inside the disperser.

15. The treatment apparatus according to claim 12, wherein the water replenishing unit has:
a water tank that contains water,
a pipeline that communicates the disperser and the water tank with each other, and
a pump that is disposed above the pipeline and feeds water within the water tank to the disperser.

16. The treatment apparatus according to claim 15, further comprising:
a displacement unit that, after the water has been fed to the disperser by the water replenishing unit, displaces any water within the disperser with solvent.

17. The treatment apparatus according to claim 16, wherein the displacement unit has:
a solvent tank containing solvent, and
a pipeline that communicates the disperser and the solvent tank with each other.

18. The treatment apparatus according to claim 12, wherein the metal member is a blade.
